(19) United States
(12) Patent Application Publication
(10) Pub. No.: US 2024/0249330 A1
(43) Pub. Date: Jul. 25, 2024

(54) SYSTEM AND METHOD OF ORGANIZING PRODUCTS AND OFFERS OF THE PRODUCTS

(71) Applicant: Dell Products L.P., Round Rock, TX (US)

(72) Inventor: Shibi Panikkar, Bangalore (IN)

(21) Appl. No.: 18/157,488

(22) Filed: Jan. 20, 2023

(51) Int. Cl. G06Q 30/0601

(52) U.S. Cl. CPC G06Q 30/0627

(57) ABSTRACT

In one or more embodiments, one or more systems, one or more methods, and/or one or more processes may: receive multiple information respectively associated with products; store, in a first node of a recursive data structure at a first level of the data structure, pointers to first nodes, at a second level of the data structure, respectively associated with the products; respectively store the multiple information in the first nodes; for each product of the products: respectively store one or more attributes and one or more selections associated with the product in nodes of the data structure at a third level of the data structure; and for each product of the products: for each selection of the one or more selections: respectively store one or more attributes associated with the selection in one or more nodes of the data structure at a fourth level of the data structure.

### BACKGROUND

### Field of the Disclosure

This disclosure relates generally to information handling systems and more particularly to organizing products and offers of the products.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In one or more embodiments, one or more systems, one or more methods, and/or one or more processes may receive multiple of information respectively associated with multiple products; may store, in a first node of a recursive data structure at a first level of the recursive data structure, pointers to first multiple nodes, at a second level of the recursive data structure, respectively associated with the multiple products; may respectively store the multiple information in the first multiple nodes; for each product of the multiple products: may receive one or more attributes associated with the product and one or more selections associated with the product; and may respectively store the one or more attributes associated with the product and the one or more selections associated with the product in multiple nodes of the recursive data structure at a third level of the recursive data structure; and for each product of the multiple products: for each selection of the one or more selections associated with the product: may receive one or more attributes associated with the selection; and may respectively store the one or more attributes associated with the selection in one or more nodes of the recursive data structure at a fourth level of the recursive data structure.

In one or more embodiments, a first attribute of the one or more attributes associated with the product may be a time attribute associated with the product. In one or more embodiments, the one or more attributes associated with the product may include multiple attributes associated with the product. In one or more embodiments, the one or more systems, the one or more methods, and/or the one or more processes may further, for each product of the multiple products, respectively store multiple addresses of the multiple nodes of at the third level of the recursive data structure in a node of the first multiple nodes associated with the product. In one or more embodiments, the recursive data structure may include a file system. In one example, data of a node of the recursive data structure may be stored via a directory name or a file name of the file system. In another example, respectively storing the one or more attributes associated with the product and the one or more selections associated with the product in the multiple nodes of the recursive data structure at the third level of the recursive data structure may include: respectively storing the one or more attributes associated with the product in one or more files of a file system and respectively storing the one or more selections associated with the product in one or more directories of the file system.

### BRIEF DESCRIPTION OF THE DRAWINGS

For a more complete understanding of the present disclosure and its features/advantages, reference is now made to the following description, taken in conjunction with the accompanying drawings, which are not drawn to scale, and in which:

FIG. 1 illustrates an example of an information handling system, according to one or more embodiments;

FIG. 2A illustrates an example of attributes associated with products, according to one or more embodiments;

FIG. 2B illustrates an example of information handling systems communicatively coupled to a network, according to one or more embodiments;

FIG. 3A illustrates an example of configuring a product, according to one or more embodiments;

FIG. 3B illustrates an example of a rate card and an offer associated with a product, according to one or more embodiments;

FIG. 4 illustrates an example of a data structure that stores information associated with products, selections associated with the products, and attributes associated with the products, according to one or more embodiments; and

to FIG. 5 illustrates an example of a method of configuring a data structure associated with multiple products, according to one or more embodiments.

### DETAILED DESCRIPTION

In the following description, details are set forth by way of example to facilitate discussion of the disclosed subject matter. It should be apparent to a person of ordinary skill in the field, however, that the disclosed embodiments are examples and not exhaustive of all possible embodiments.

As used herein, a reference numeral refers to a class or type of entity, and any letter following such reference numeral refers to a specific instance of a particular entity of that class or type. Thus, for example, a hypothetical entity referenced by ‘12A’ may refer to a particular instance of a particular class/type, and the reference ‘12’ may refer to a collection of instances belonging to that particular class/type or any one instance of that class/type in general.

In one or more embodiments, a manufacturer may receive an order (e.g., a request for one or more goods and/or one or more services). For example, the order may pass through a supply chain system associated with a manufacturer of information handling systems. For instance, the supply chain may include one or more of sales, tax, accounting, and services, among others. As an example, each portion of the supply chain may perform one or more processes associated with a product (e.g., one or more goods and/or one or more services) of the order. In one or more embodiments, one or more attributes and/or one or more rules may be associated with the product of the order. For example, each portion of the supply chain may include one or more attributes and/or one or more rules associated with the product of the order. In one instance, an accounting portion of the supply chain may include first one or more attributes and/or first one or more rules associated with the product of the order. In another instance, an accounting portion of the supply chain may include second one or more attributes and/or second one or more rules associated with the product of the order.

In one or more embodiments, a stock keeping unit (SKU) may be associated with a product. For example, a seller of the product may utilize a SKU identify and/or track inventory an/or stock of the product. For instance, a SKU may include a unique code and/or a unique identifier. As an example, the unique code and/or the unique identifier may include one or more letters, one or more numbers, and/or one or more symbols that may identify the product and/or one or more characteristics associated with the product. For instance, the one or more characteristics associated with the product may include one or more of a manufacturer, a brand, a style, a color, a size, a service level, a subscription, and a subscription length of time, among others.

In one or more embodiments, a subscription offer may be associated via different selection combinations. For example, a subscription offer may be offered for sale with different selection combinations. For instance, selection combinations may include attributes associated with the subscription offer. As an example, an entity may subscribe to a subscription with different selection combinations, such as: a bronze plan with five terabytes (5 TB) backup data storage for a three-year commitment with monthly billing; a gold plan with ten terabytes (10 TB) backup data storage for a three-year commitment with monthly billing; a bronze plan with 5 TB backup data storage for a one-year commitment with annual billing; and a gold plan with 10 TB backup data storage for a one-year commitment with annual billing.

In one or more embodiments, when customers subscribe with different selection combinations, one or more systems of a supply chain may necessitate and/or involve different processes associated with the different selection combinations. In one example, a bronze plan service level may be different (e.g., lower) from a gold plan service level. In a second example, a one-year contract revenue allocation may be different than a three-year contract revenue allocation. In a third example, monthly billing rate may be taxed differently than an annual billing rate. In another example, monthly billing rate may be billed differently than an annual billing rate. For instance, the monthly billing rate may be higher for twelve months than the annual billing rate.

In one or more embodiments, each of the selection combinations may be mapped to a SKU, and attributes may be defined for that SKU. In one or more embodiments, each of the selection combinations may be defined as a SKU, and an attribute may be defined to that SKU. In one or more embodiments, too many stock keeping units (SKUs) may be defined. For example, an offer may be associated with n selections, and each selection may be associated with k values (e.g., attributes). For instance, a total number of selection combinations for n selections with k values will be:

$$( \begin{matrix}n \\ k\end{matrix} ) = \frac{n !}{k ! ( n - k ) !} = {{\prod }^{k}}_{i = 1} \frac{n + 1 - i}{i} \cdot$$

In one or more embodiments, there may be no difference in behavior in different systems for different selection combinations. In one or more embodiments, there may be differences in different contracts. As such, SKUs may be associated with attributes to be defined for those that have same behaviors, which may lead to attribute duplication, for instance.

In one or more embodiments, a time to author an offer may be lengthy, as there may be a time spent to define many SKUs and attributes for each of the SKUs. In one or more embodiments, management of attributes may become unwieldy as selection combinations increase. In one or more embodiments, reducing SKU proliferation may be advantageous. For example, reducing SKU proliferation may reduce an amount of storage for a number of subscriptions.

In one or more embodiments, one or more systems, one or more methods, and/or one or more processes may utilize a hierarchical model for an offer according to one or more of an offer definition, selection criteria, and a selection combinations definition, among others. For example, the hierarchical model may permit different entities to define variability in different levels of a hierarchy, which may be automatically resolved in lower levels.

In one or more embodiments, the one or more systems, the one or more methods, and/or the one or more processes may utilize a single SKU or a single offer identifier for an offer. In one or more embodiments, a number of attributes, as defined in a hierarchical level, may be reduced. For example, duplication of attributes, as defined in the hierarchical level, may be reduced. For instance, offer on boarding time may be reduced since as no SKU and no corresponding attributes need to be defined. As an example, attribute maintenance, as a single SKU or no SKU and corresponding attributes, may be reduced.

In one or more embodiments, if a process behavior is at an offer level, one or more attributes may be defined. For example, there may be no change of behavior at a selection criteria (e.g., pivotal attributes) level or at a selection combination level. For instance, tax (e.g., sales tax) may be the same for an offer, irrespective of different performance variations or contract commitment variations. As an example, all selection combinations may be referenced to an offer level definition.

In one or more embodiments, if a process behavior is at a selection criteria level, attributes for a different pivotal level may be added. For example, tax may vary if a customer selects a one-year contract or a three-year contract. For instance, all selection combinations that may fall under that criteria may be referenced to the offer level definition.

In one or more embodiments, if a process behavior is at a combination of selection level, an attribute at a combination of selection combination may be defined. As an example, services may vary between a first bronze plan with a three-year commitment and monthly billing and a second bronze plan with a three-year commitment and annual billing. In one or more embodiments, when a customer selects selection combinations, the selection combination identifier in the order may be passed. In one or more embodiments, one or more domain processes may call a subscription domain attribution resolver by passing the selection combination identifier to obtain an appropriate domain attribution for the customer selection

In one or more embodiments, when a product author defines domain attributes at an offer level, all selection combinations may have the reference to the same domain attributes (e.g., no duplications). In one or more embodiments, when a product author defines domain attributes at a selection criteria level, all selection combinations associated with that selection criteria may have reference to the defined attributes. For example, the selection criteria level may include a term. For instance, the term may be one year, three years, etc.

As an example, if a one-year term is mapped with an identifier of “ABC” and three-year term is mapped with an identifier of “XYZ” for accounting, then a bronze plan with five terabytes (5 TB) backup for a three-year commitment with monthly billing may be mapped to “XYZ”; a gold plan with ten terabytes (10 TB) backup for a three-year commitment with monthly billing may be mapped to “XYZ”; a bronze plan with 5 TB backup for a one-year commitment with monthly billing may be mapped to “ABC”; and a gold plan with 10 TB backup for a one-year commitment with monthly billing may be mapped to “ABC”.

In one or more embodiments, one or more subscriptions and one or more attributes associated with the one or more subscriptions may be stored via a data structure. For example, the data structure may include a tree data structure. For instance, a tree data structure may be referred to as a “tree”. In one or more embodiments, a tree may be utilized as an abstract data type, which may represent a hierarchical tree structure with a set of connected nodes. For example, each node in a tree may be connected to multiple children. For instance, each node in the tree may be connected to at only one parent node, except for a root node. As an example, the root node may not have a parent node. In one instance, a tree may not have any cycles or “loops” (no node may be its own ancestor). In another instance, each child node may be treated like a root node of its own subtree, which may make recursion a useful technique for traversal of a tree.

In one or more embodiments, a tree may be empty with no nodes, a tree may include only one node, or a tree may include one or more subtrees. For example, a tree may be a recursive data structure. In one or more embodiments, a single node of a tree may be distinguished as a root of the tree. For example, the root of the tree may not have any parent node. For example, the root of the tree may only have zero or more child nodes. In one or more embodiments, each node of a tree, excluding the root node, may be connected via an edge from exactly one parent node. For example, a direction may include a parent node to a child node.

In one or more embodiments, a node of a tree may have any number of child nodes. In one example, a node of a tree that does not have any child node may be called a leaf node or an external node. In another example, a node of a tree that is not a leaf node may be called an internal node. For instance, an internal node may have at least one child node.

In one or more embodiments, multiple nodes with the same parent node may be called sibling nodes. In one or more embodiments, a height of a node may be a number of edges from the node to a deepest leaf. For example, a height of a tree may be a height of a root node of the tree. In one or more embodiments, a node of a tree may store data. For example, the data of the node may be stored via a data structure. In one or more embodiments, a general tree may be converted to a binary tree (e.g., a binary search tree). For example, a search of the binary tree may be more efficient than searching the general tree.

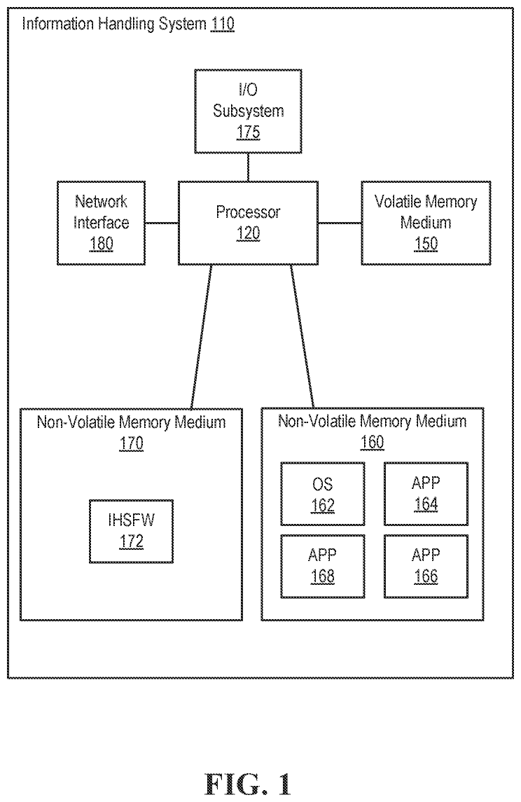

Turning now to FIG. 1, an example of an information handling system is illustrated, according to one or more embodiments. An information handling system (IHS) 110 may include a hardware resource or an aggregate of hardware resources operable to compute, classify, process, transmit, receive, retrieve, originate, switch, store, display, manifest, detect, record, reproduce, handle, and/or utilize various forms of information, intelligence, or data for business, scientific, control, entertainment, or other purposes, according to one or more embodiments. For example, IHS 110 may be a computer system. For instance, the computer system may be a personal computer, a desktop computer system, a laptop computer system, a server computer system, a mobile device, a tablet computing device, a personal digital assistant (PDA), a consumer electronic device, an electronic music player, an electronic camera, an electronic video player, a wireless access point, a network storage device, or another suitable device and may vary in size, shape, performance, functionality, and price. In one or more embodiments, a portable IHS 110 may include or have a form factor of that of or similar to one or more of a laptop, a notebook, a telephone, a tablet, and a PDA, among others. For example, a portable IHS 110 may be readily carried and/or transported by a user (e.g., a person). In one or more embodiments, components of IHS 110 may include one or more storage devices, one or more communications ports for communicating with external devices as well as various input and output (I/O) devices, such as a keyboard, a mouse, and a video display, among others. In one or more embodiments, IHS 110 may include one or more buses operable to transmit communication between or among two or more hardware components. In one example, a bus of IHS 110 may include one or more of a memory bus, a peripheral bus, and a local bus, among others. In another example, a bus of IHS 110 may include one or more of a Micro Channel Architecture (MCA) bus, an Industry Standard Architecture (ISA) bus, an Enhanced ISA (EISA) bus, a Peripheral Component Interconnect (PCI) bus, HyperTransport (HT) bus, an inter-integrated circuit (I2C) bus, a serial peripheral interface (SPI) bus, a low pin count (LPC) bus, an enhanced serial peripheral interface (eSPI) bus, a universal serial bus (USB), a system management bus (SMBus), and a Video Electronics Standards Association (VESA) local bus, among others.

In one or more embodiments, IHS 110 may include firmware that controls and/or communicates with one or more hard drives, network circuitry, one or more memory devices, one or more I/O devices, and/or one or more other peripheral devices. For example, firmware may include software embedded in an IHS component utilized to perform tasks. In one or more embodiments, firmware may be stored in non-volatile memory, such as storage that does not lose stored data upon loss of power. In one example, firmware associated with an IHS component may be stored in non-volatile memory that is accessible to one or more IHS components. In another example, firmware associated with an IHS component may be stored in non-volatile memory that may be dedicated to and includes part of that component. For instance, an embedded controller may include firmware that may be stored via non-volatile memory that may be dedicated to and includes part of the embedded controller.

As shown, IHS 110 may include a processor 120, a volatile memory medium 150, non-volatile memory media 160 and 170, an I/O subsystem 175, and a network interface 180. As illustrated, volatile memory medium 150, non-volatile memory media 160 and 170, I/O subsystem 175, and network interface 180 may be communicatively coupled to processor 120.

In one or more embodiments, one or more of volatile memory medium 150, non-volatile memory media 160 and 170, I/O subsystem 175, and network interface 180 may be communicatively coupled to processor 120 via one or more buses, one or more switches, and/or one or more root complexes, among others. In one example, one or more of volatile memory medium 150, non-volatile memory media 160 and 170, I/O subsystem 175, and network interface 180 may be communicatively coupled to processor 120 via one or more PCI-Express (PCIe) root complexes. In another example, one or more of I/O subsystem 175 and network interface 180 may be communicatively coupled to processor 120 via one or more PCIe switches.

In one or more embodiments, the term “memory medium” may mean a “storage device”, a “memory”, a “memory device”, a “tangible computer readable storage medium”, and/or a “computer-readable medium”. For example, computer-readable media may include, without limitation, storage media such as a direct access storage device (e.g., a hard disk drive, a floppy disk, etc.), a sequential access storage device (e.g., a tape disk drive), a compact disk (CD), a CD-ROM, a digital versatile disc (DVD), a random access memory (RAM), a read-only memory (ROM), a one-time programmable (OTP) memory, an electrically erasable programmable read-only memory (EEPROM), and/or a flash memory, a solid state drive (SSD), or any combination of the foregoing, among others.

In one or more embodiments, one or more protocols may be utilized in transferring data to and/or from a memory medium. For example, the one or more protocols may include one or more of small computer system interface (SCSI), Serial Attached SCSI (SAS) or another transport that operates with the SCSI protocol, advanced technology attachment (ATA), serial ATA (SATA), a USB interface, an Institute of Electrical and Electronics Engineers (IEEE) 1394 interface, a Thunderbolt interface, an advanced technology attachment packet interface (ATAPI), serial storage architecture (SSA), integrated drive electronics (IDE), or any combination thereof, among others.

Volatile memory medium 150 may include volatile storage such as, for example, RAM, DRAM (dynamic RAM), EDO RAM (extended data out RAM), SRAM (static RAM), etc. One or more of non-volatile memory media 160 and 170 may include nonvolatile storage such as, for example, a read only memory (ROM), a programmable ROM (PROM), an erasable PROM (EPROM), an electrically erasable PROM, NVRAM (non-volatile RAM), ferroelectric RAM (FRAM), a magnetic medium (e.g., a hard drive, a floppy disk, a magnetic tape, etc.), optical storage (e.g., a CD, a DVD, a BLU-RAY disc, etc.), flash memory, a SSD, etc. In one or more embodiments, a memory medium can include one or more volatile storages and/or one or more nonvolatile storages.

In one or more embodiments, network interface 180 may be utilized in communicating with one or more networks and/or one or more other information handling systems. In one example, network interface 180 may enable IHS 110 to communicate via a network utilizing a suitable transmission protocol and/or standard. In a second example, network interface 180 may be coupled to a wired network. In a third example, network interface 180 may be coupled to an optical network. In another example, network interface 180 may be coupled to a wireless network. In one instance, the wireless network may include a cellular telephone network. In a second instance, the wireless network may include a satellite telephone network. In another instance, the wireless network may include a wireless Ethernet network (e.g., a Wi-Fi network, an IEEE 802.11 network, etc.).

In one or more embodiments, network interface 180 may be communicatively coupled via a network to a network storage resource. For example, the network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, an Internet or another appropriate architecture or system that facilitates the communication of signals, data and/or messages (generally referred to as data). For instance, the network may transmit data utilizing a desired storage and/or communication protocol, including one or more of Fibre Channel, Frame Relay, Asynchronous Transfer Mode (ATM), Internet protocol (IP), other packet-based protocol, Internet SCSI (iSCSI), or any combination thereof, among others.

In one or more embodiments, processor 120 may execute processor instructions in implementing at least a portion of one or more systems, at least a portion of one or more flowcharts, at least a portion of one or more methods, and/or at least a portion of one or more processes described herein. In one example, processor 120 may execute processor instructions from one or more of memory media 150, 160, and 170 in implementing at least a portion of one or more systems, at least a portion of one or more flowcharts, at least a portion of one or more methods, and/or at least a portion of one or more processes described herein. In another example, processor 120 may execute processor instructions via network interface 180 in implementing at least a portion of one or more systems, at least a portion of one or more flowcharts, at least a portion of one or more methods, and/or at least a portion of one or more processes described herein.

In one or more embodiments, processor 120 may include one or more of a system, a device, and an apparatus operable to interpret and/or execute program instructions and/or process data, among others, and may include one or more of a microprocessor, a microcontroller, a digital signal processor (DSP), an application specific integrated circuit (ASIC), and another digital or analog circuitry configured to interpret and/or execute program instructions and/or process data, among others. In one example, processor 120 may interpret and/or execute program instructions and/or process data stored locally (e.g., via memory media 150, 160, and 170 and/or another component of IHS 110). In another example, processor 120 may interpret and/or execute program instructions and/or process data stored remotely (e.g., via a network storage resource).

In one or more embodiments, I/O subsystem 175 may represent a variety of communication interfaces, graphics interfaces, video interfaces, user input interfaces, and/or peripheral interfaces, among others. For example, I/O subsystem 175 may include one or more of a touch panel and a display adapter, among others. For instance, a touch panel may include circuitry that enables touch functionality in conjunction with a display that is driven by a display adapter.

As shown, non-volatile memory medium 160 may include an operating system (OS) 162, and applications (APPs) 164-168. In one or more embodiments, one or more of OS 162 and APPs 164-168 may include processor instructions executable by processor 120. In one example, processor 120 may execute processor instructions of one or more of OS 162 and APPs 164-168 via non-volatile memory medium 160. In another example, one or more portions of the processor instructions of the one or more of OS 162 and APPs 164-168 may be transferred to volatile memory medium 150, and processor 120 may execute the one or more portions of the processor instructions of the one or more of OS 162 and APPs 164-168 via volatile memory medium 150.

As illustrated, non-volatile memory medium 170 may include information handling system firmware (IHSFW) 172. In one or more embodiments, IHSFW 172 may include processor instructions executable by processor 120. For example, IHSFW 172 may include one or more structures and/or one or more functionalities of and/or compliant with one or more of a basic input/output system (BIOS), an Extensible Firmware Interface (EFI), a Unified Extensible Firmware Interface (UEFI), and an Advanced Configuration and Power Interface (ACPI), among others. In one instance, processor 120 may execute processor instructions of IHSFW 172 via non-volatile memory medium 170. In another instance, one or more portions of the processor instructions of IHSFW 172 may be transferred to volatile memory medium 150, and processor 120 may execute the one or more portions of the processor instructions of IHSFW 172 via volatile memory medium 150.

In one or more embodiments, OS 162 may include a management information exchange. In one example, the management information exchange may permit multiple components to exchange management information associated with managed elements and/or may permit control and/or management of the managed elements. In another example, the management information exchange may include a driver and/or a driver model that may provide an OS interface through which managed elements (e.g., elements of IHS 110) may provide information and/or notifications, among others. In one instance, the management information exchange may be or include a Windows Management Interface (WMI) for ACPI (available from Microsoft Corporation). In another instance, the management information exchange may be or include a Common Information Model (CIM) (available via the Distributed Management Task Force). In one or more embodiments, the management information exchange may include a combination of the WMI and the CIM. For example, WMI may be and/or may be utilized as an interface to the CIM. For instance, the WMI may be utilized to provide and/or send CIM object information to OS 162.

In one or more embodiments, processor 120 and one or more components of IHS 110 may be included in a system-on-chip (SoC). For example, the SoC may include processor 120 and a platform controller hub (not specifically illustrated).

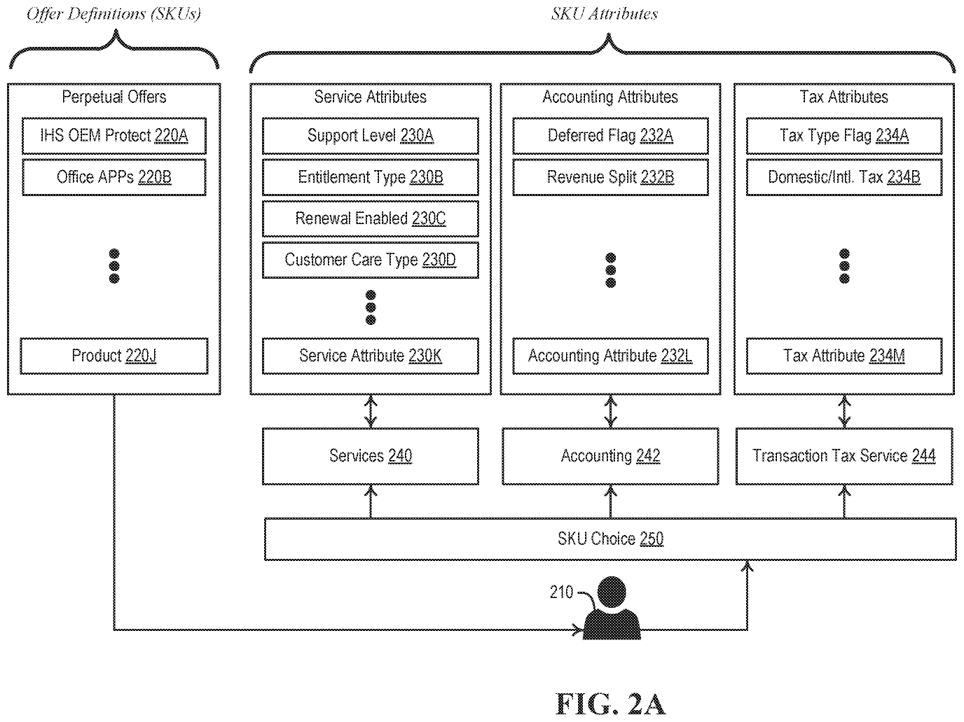

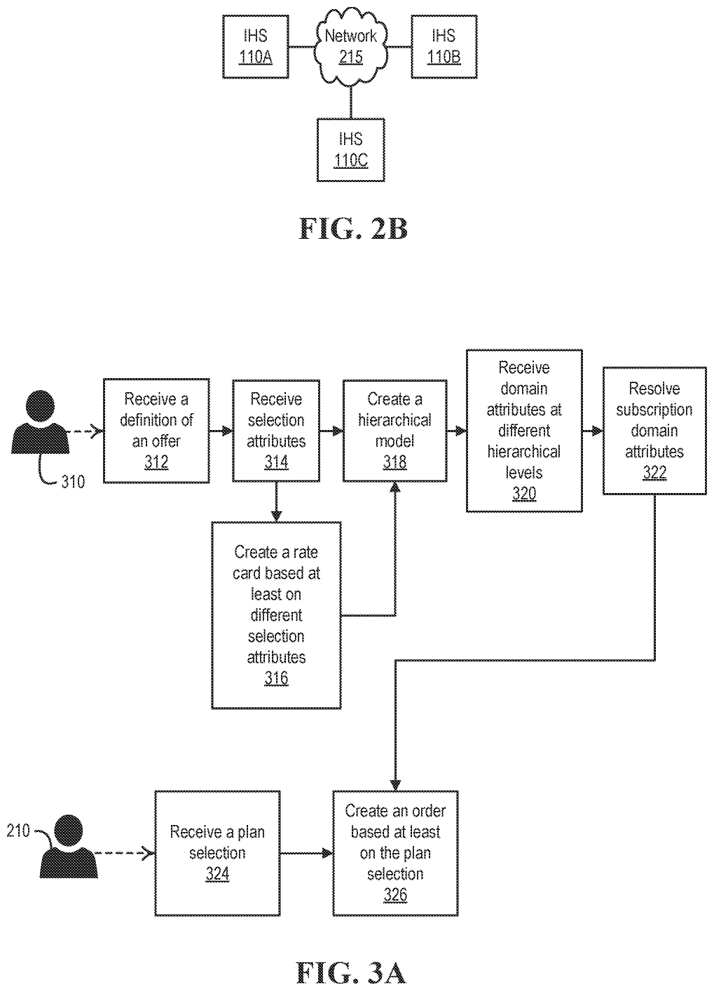

Turning now to FIG. 2A, an example of attributes associated with products is illustrated, according to one or more embodiments. In one or more embodiments, a manufacturer may receive an order (e.g., a request for one or more goods and/or one or more services). For example, the manufacturer may receive the order from a person 210 (e.g., a customer). In one instance, the manufacturer may receive the order, via an IHS 110A, from an IHS 110B operated by person 210, as shown in FIG. 2B. As an example, IHS 110A may be associated with the manufacturer.

In one or more embodiments, IHS 110B may be communicatively coupled to IHS 110A via a network 215. In one or more embodiments, network 215 may include a wired network, a wireless network, an optical network, or a combination of the foregoing, among others. For example, network 215 may include and/or be coupled to various types of communications networks. For instance, network 215 may include and/or be coupled to a LAN, a WAN (e.g., a private WAN, a corporate WAN, a public WAN, etc.), an Internet, a public switched telephone network (PSTN), a cellular telephone network, a satellite telephone network, or a combination of the foregoing, among others. In one or more embodiments, information handling systems may be communicatively coupled to network 215. For example, information handling systems (IHSs) 110A-110C may be communicatively coupled to network 215. For instance, a first information handling system of IHSs 110A-110C may communicate with a second information handling system of IHSs 110A-110C, different from the first information handling system, via network 215.

In one or more embodiments, the order may pass through a supply chain system associated with a manufacturer of information handling systems. For example, the supply chain may include one or more of sales, tax, accounting, and services, among others. For instance, each portion of the supply chain may perform one or more processes associated with a product (e.g., one or more goods and/or one or more services) of the order. As an example, the product may be a product of products 220A-220J.

In one or more embodiments, one or more attributes and/or one or more rules may be associated with a product 220 of an order. For example, each portion of the supply chain may include one or more attributes and/or one or more rules associated with the product of the order. In one instance, a services portion 240 of the supply chain may include one or more attributes 230A-30K. In a second instance, an accounting portion 242 of the supply chain may include first one or more attributes 232A-232L. In another instance, a transaction tax service portion 244 of the supply chain may include second one or more attributes 234A-234M.

In one or more embodiments, person 210 may provide a selection of a product 220 to a SKU choice 250. For example, IHS 110B associated with person 210 may provide a selection of a product 220 to a SKU choice 250. In one or more embodiments, SKU choice 250 may provide the selection of the product 220 to one or more of supply chain portions 240, 242, and 244, among others.

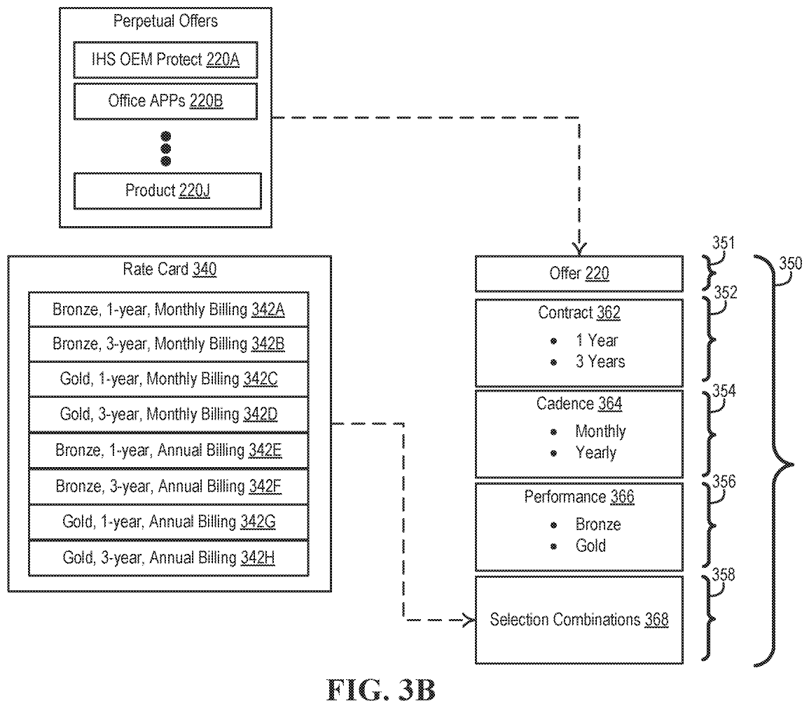

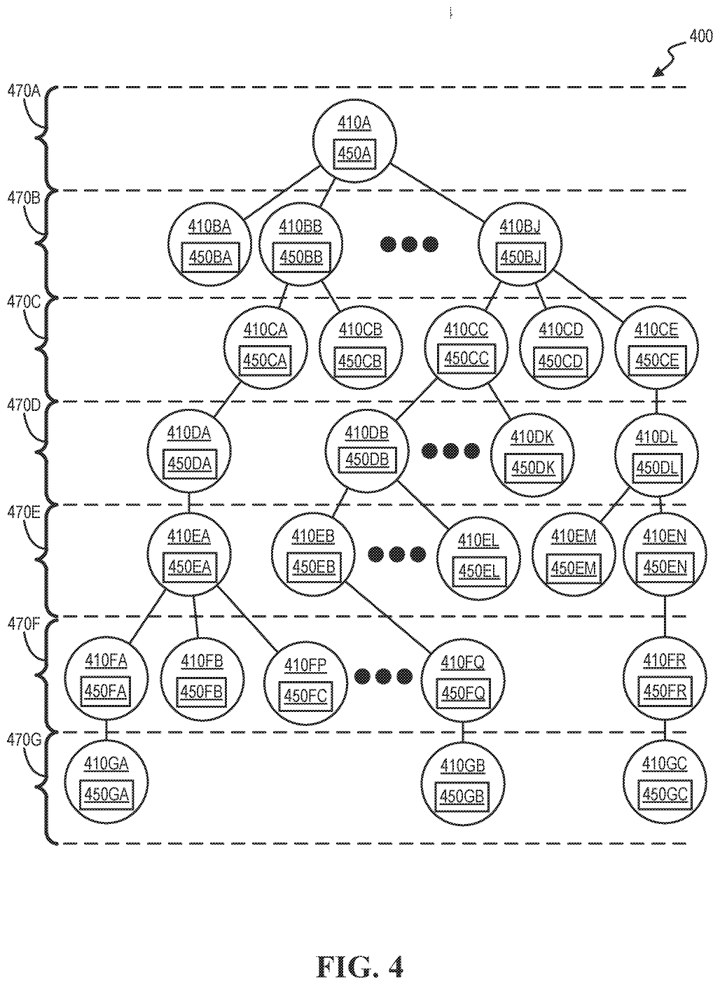

Turning now to FIG. 3A, an example of configuring a product is illustrated, according to one or more embodiments. In one or more embodiments, an offer definer 310 (e.g., a person) may define one or more offers and/or one or more products. For example, offer definer 310 may define one or more offers and/or one or more products for a manufacturer of information handling systems. In one or more embodiments, offer definer 310 may provide one or more definitions, one or more products, one or more rules associated with the one or more products, and/or one or more attributes associated with the one or more products to an information handling system. For example, offer definer 310 may provide the one or more definitions, the one or more products, the one or more rules associated with the one or more products, and/or the one or more attributes associated with the one or more products to IHS 110A associated with the manufacturer of information handling systems. For instance, IHS 110A associated with the manufacturer of information handling systems may include a web server. As an example, offer definer 310 may utilize IHS 110C to provide the one or more definitions, the one or more products, the one or more rules associated with the one or more products, and/or the one or more attributes associated with the one or more products to IHS 110A. In one or more embodiments, a product may be or may include an offer. For example, a product may be or may include a subscription offer.

At 312, a definition of an offer may be received. For example, IHS 110A associated with the manufacturer of information handling systems may receive the definition of the offer from offer definer 310. For instance, IHS 110A associated with the manufacturer of information handling systems may receive the definition of the offer from IHS 110C associated with offer definer 310. As an example, IHS 110A associated with the manufacturer of information handling systems may receive the definition of the offer via network 215. In one or more embodiments, the definition of the offer may include a definition of a subscription offer. In one or more embodiments, the definition of the offer may include a definition of a real product offer. For example, the real product offer may include an information handling system.

At 314, selection attributes associated with the definition of the offer may be received. For example, IHS 110A associated with the manufacturer of information handling systems may receive the selection attributes associated with the definition of the offer from offer definer 310. For instance, IHS 110A may receive the selection attributes associated with the definition of the offer from IHS 110C associated with offer definer 310. As an example, IHS 110A associated with the manufacturer of information handling systems may receive the selection attributes associated with the definition of the offer via network 215. For instance, IHS 110C may be communicatively coupled to IHS 110A via network 215.

At 316, a rate card may be created based at least on the selection attributes associated with the definition of the offer. For example, IHS 110A associated with the manufacturer of information handling systems may create a rate card based at least on the selection attributes associated with the definition of the offer. For instance, IHS 110A may create a rate card 340, as shown in FIG. 3B, based at least on the selection attributes associated with the definition of the offer. In one or more embodiments, rate card 340 may include rates 342A-342H associated with a product 220 of products 220A-220J.

At 318, a hierarchical model may be created. For example, IHS 110A associated with the manufacturer of information handling systems may create a hierarchical model. For instance, IHS 110A associated with the manufacturer of information handling systems may create a hierarchical model 350, as illustrated in FIG. 3B. At 320, domain attributes at different hierarchical levels may be received. For example, IHS 110A associated with the manufacturer of information handling systems may receive domain attributes at different hierarchical levels 351-358, as illustrated in FIG. 3B.

In one or more embodiments, hierarchical model 350 may include levels 351-358. In one example, level 351 may include offer 220. In a second example, level 352 may include a contract 362. In a third example, level 354 may include a cadence 364. In a fourth example, level 356 may include a performance 366. In another example, level 358 may include selections 368. For instance, selections 368 may be based at least on rate card 340.

At 322, subscription domain attributes may be resolved. For example, IHS 110A associated with the manufacturer of information handling systems may resolve subscription domain attributes. At 324, a plan selection may be received. For example, IHS 110A associated with the manufacturer of information handling systems may receive a plan selection. For instance, IHS 110A associated with the manufacturer of information handling systems may receive a plan selection from person 210. As an example, IHS 110A may receive a plan selection from IHS 110B utilized by person 210. For instance, IHS 110A may receive a plan selection via network 215. At 326, an order based at least on the plan selection may be created. For example, IHS 110A associated with the manufacturer of information handling systems may create an order based at least on the plan selection. For instance, IHS 110A may create an order based at least on the plan selection and based at least on the subscription domain attributes.

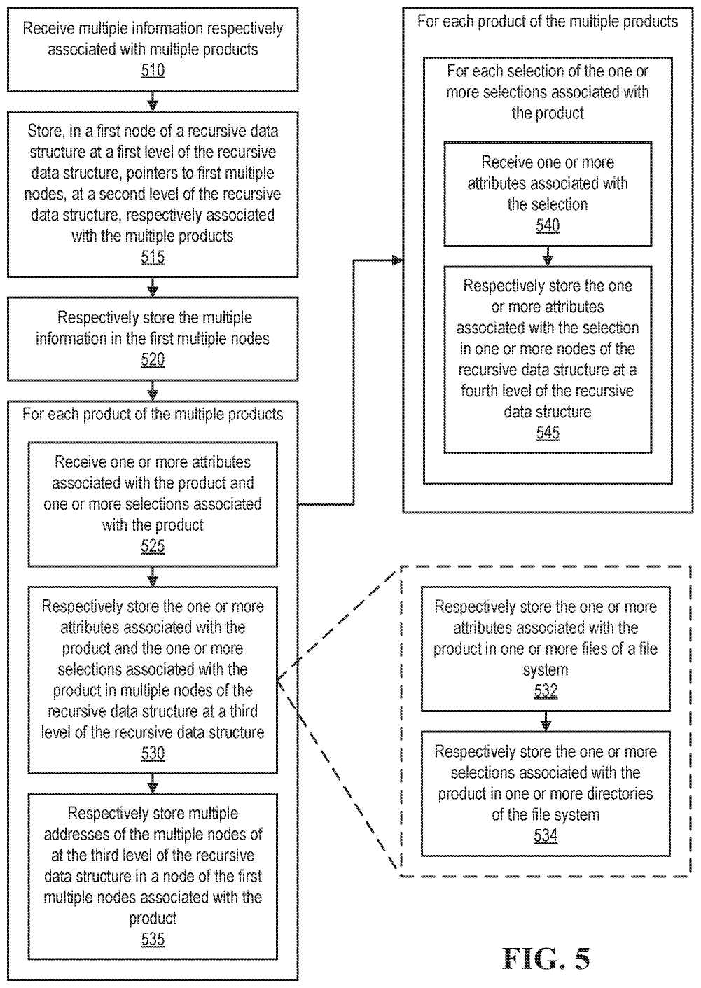

Turning now to FIG. 4, an example of a data structure that stores information associated with products, selections associated with the products, and attributes associated with the products is illustrated, according to one or more embodiments. In one or more embodiments, a data structure 400 may include multiple nodes 410. For example, data structure 400 may include or may be a recursive data structure. In one or more embodiments, data structure 400 may be or may include a tree data structure. For example, the tree data structure may include multiple nodes. For instance, data structure 400 may include nodes 410A-410GC.

In one or more embodiments, a node 410A may be associated with a selection. For example, node 410A may be associated with a selection of products. In one or more embodiments, a level 470A of data structure 400 may include node 410A. In one or more embodiments, node 410A may store data 450A. In one or more embodiments, data 450 may store an array of data. For example, data 450 may store an array of characters. For instance, data 450 may store a string of characters.

In one or more embodiments, nodes 410BA-410BJ may be associated with respective products. For example, a level 470B of data structure 400 may include nodes 410BA-410BJ. In one instance, node 410A may store pointers to nodes 410BA-410BJ. In another instance, nodes 410BA-410BJ may respectively store data 450BA-450BJ. In one or more embodiments, a pointer to a node 410 may be or may include an address. In one example, the address may be or may include an address of a memory medium. In another example, the address may be or may include an index of an array, which may be stored by a memory medium.

In one or more embodiments, a product associated with node 410BA may not have any selections and may not have any attributes. For example, the product associated with node 410BA may not have any configuration options. For instance, node 410BA may be a leaf node of data structure 400. In one or more embodiments, a product associated with node 410BB may store data 450BB. For example, node 410BB may store pointers to nodes 410CA and 410CB.

In one or more embodiments, node 410CB may be an optional attribute associated with the product associated with node 410BB. In one example, the optional attribute associated with the product associated with node 410BB may be selected to include an option associated with the product associated with node 410BB. In another example, the optional attribute associated with the product associated with node 410BB may not be selected to not include (e.g., exclude) the option associated with the product associated with node 410BB. In one or more embodiments, node 410CB may store data 450CB. For example, node 410CB may not store a pointer to another node 410. For instance, node 410CB may be a leaf node of data structure 400.

In one or more embodiments, node 410CA may be an optional selection associated with the product associated with node 410BB. In one example, the optional selection associated with the product associated with node 410BB may be selected to include a selection associated with the product associated with node 410BB. In another example, the optional selection associated with the product associated with node 410BB may not be selected to not include (e.g., exclude) the option selection with the product associated with node 410BB. In one or more embodiments, node 410CA may store data 450CA. For example, node 410CB may store a pointer to node 410DA. For instance, node 410CB may not be a leaf node of data structure 400.

In one or more embodiments, node 410DA may be an optional selection associated with the selection associated with node 410CA. In one example, the optional selection associated with the product associated with node 410CA may be selected to include a selection associated with the product associated with node 410BB. In another example, the optional selection associated with the product associated with node 410BB may not be selected to not include (e.g., exclude) the option selection with the product associated with node 410BB. In one or more embodiments, node 410DA may store data 450DA. For example, node 410CA may store a pointer to node 410DA. For instance, node 410DA may not be a leaf node of data structure 400.

In one or more embodiments, node 410EA may be an optional selection associated with the selection associated with node 410DA. In one example, the optional selection associated with the product associated with node 410DA may be selected to include a selection associated with the product associated with node 410BB. In another example, the optional selection associated with the product associated with node 410BB may not be selected to not include (e.g., exclude) the option selection with the product associated with node 410BB. In one or more embodiments, node 410EA may store data 450EA. For example, node 410DA may store a pointer to node 410EA. For instance, node 410EA may not be a leaf node of data structure 400.

In one or more embodiments, node 410FA may be an optional selection associated with the selection associated with node 410EA. In one example, the optional selection associated with the product associated with node 410EA may be selected to include a selection associated with the product associated with node 410BB. In another example, the optional selection associated with the product associated with node 410BB may not be selected to not include (e.g., exclude) the option selection with the product associated with node 410BB. In one or more embodiments, node 410FA may store data 450FA. For example, node 410EA may store a pointer to node 410FA. For instance, node 410FA may not be a leaf node of data structure 400.

In one or more embodiments, node 410GA may be an optional attribute associated with the selection associated with node 410FA. In one example, the optional attribute associated with the product associated with node 410BB may be selected to include an attribute associated with the product associated with node 410BB. In another example, the optional selection associated with the product associated with node 410BB may not be selected to not include (e.g., exclude) the attribute selection with the product associated with node 410BB. In one or more embodiments, node 410GA may store data 450GA. For example, node 410EA may store a pointer to node 410GA. For instance, node 410FA may be a leaf node of data structure 400.

In one or more embodiments, nodes 410FB and 410FC may be optional attributes associated with the selection associated with node 410EA. In one example, nodes 410FB and 410FC may respectively store data 450FB and 450FC. In another example, node 410EA may store pointers to nodes 410FB and 410FC. For instance, nodes 410FB and 410FC may be leaf nodes of data structure 400.

In one or more embodiments, a product associated with node 410BJ may store data 450BJ. For example, node 410BJ may store pointers to nodes 410CC-410CE. In one or more embodiments, nodes 410CC and 410CE may be associated with selections of the product associated with node 410BJ. In one example, nodes 410CC and 410CE may respectively store data 450CC and 450CE. In another example, nodes 410CC and 410CE may be leaf nodes of data structure 400. In one or more embodiments, node 410CB may be associated with an attribute of the product associated with node 410BJ. For example, node 410CB may store data 450CB. For instance, node 410CB may be a leaf node of data structure 400.

In one or more embodiments, node 410CD may be associated with an optional attribute of the product associated with node 410BJ. For example, node 410CD may store data 450CD. For instance, node 410CD may be a leaf node of data structure 400. In one or more embodiments, node 410DB may be an optional selection associated with the selection associated with node 410CC. In one example, the optional selection associated with the product associated with node 410CC may be selected to include a selection associated with the product associated with node 410BJ. In another example, the optional selection associated with the product associated with node 410BJ may not be selected to not include (e.g., exclude) the option selection with the product associated with node 410BJ. In one or more embodiments, node 410DB may store data 450DB. For example, node 410CC may store a pointer to node 410DB. For instance, node 410DB may not be a leaf node of data structure 400.

In one or more embodiments, node 410DK may be an optional attribute associated with the selections associated with node 410CC. In one example, the optional attribute associated with the product associated with node 410BJ may be selected to include an option associated with the product associated with node 410BJ. In another example, the optional attribute associated with the product associated with node 410BJ may not be selected to not include (e.g., exclude) the option associated with the product associated with node 410BJ. In one or more embodiments, node 410DK may store data 450DK. For example, node 410DK may not store a pointer to another node 410. For instance, node 410DK may be a leaf node of data structure 400.

In one or more embodiments, node 410EB may be an optional selection associated with the selection associated with node 410DB. In one example, the optional selection associated with the product associated with node 410BJ may be selected to include a selection associated with the product associated with node 410BJ. In another example, the optional selection associated with the product associated with node 410BB may not be selected to not include (e.g., exclude) the option selection with the product associated with node 410BB. In one or more embodiments, node 410EB may store data 450EB. For example, node 410DB may store a pointer to node 410EB. For instance, node 410EB may not be a leaf node of data structure 400.

In one or more embodiments, node 410FQ may be an optional selection associated with the selection associated with node 410EB. In one example, the optional selection associated with the product associated with node 410BJ may be selected to include a selection associated with the product associated with node 410BJ. In another example, the optional selection associated with the product associated with node 410BB may not be selected to not include (e.g., exclude) the option selection with the product associated with node 410BJ. In one or more embodiments, node 410FQ may store data 450FQ. For example, node 410EB may store a pointer to node 410FQ. For instance, node 410FQ may not be a leaf node of data structure 400.

In one or more embodiments, node 410GB may be an optional attribute associated with the selections associated with node 410FQ. In one example, the optional attribute associated with the product associated with node 410BJ may be selected to include an option associated with the product associated with node 410BJ. In another example, the optional attribute associated with the product associated with node 410BJ may not be selected to not include (e.g., exclude) the option associated with the product associated with node 410BJ. In one or more embodiments, node 410GB may store data 450GB. For example, node 410GB may not store a pointer to another node 410. For instance, node 410GB may be a leaf node of data structure 400.

In one or more embodiments, node 410CE may be an optional selection associated with the selection associated with node 410EB. In one example, the optional selection associated with the product associated with node 410BJ may be selected to include a selection associated with the product associated with node 410BJ. In another example, the optional selection associated with the product associated with node 410BJ may not be selected to not include (e.g., exclude) the option selection with the product associated with node 410BJ. In one or more embodiments, node 410CE may store data 450CE. For example, node 410BJ may store a pointer to node 410CE. For instance, node 410CE may not be a leaf node of data structure 400.

In one or more embodiments, node 410DL may be an optional selection associated with the selection associated with node 410EB. In one example, the optional selection associated with the product associated with node 410BJ may be selected to include a selection associated with the product associated with node 410BJ. In another example, the optional selection associated with the product associated with node 410BJ may not be selected to not include (e.g., exclude) the option selection with the product associated with node 410BJ. In one or more embodiments, node 410DL may store data 450DL. For example, node 410BJ may store a pointer to node 410DL. For instance, node 410DL may not be a leaf node of data structure 400.

In one or more embodiments, node 410EM may be an optional attribute associated with the selections associated with node 410DL. In one example, the optional attribute associated with the product associated with node 410BJ may be selected to include an option associated with the product associated with node 410BJ. In another example, the optional attribute associated with the product associated with node 410BJ may not be selected to not include (e.g., exclude) the option associated with the product associated with node 410BJ. In one or more embodiments, node 410EM may store data 450EM. For example, node 410EM may not store a pointer to another node 410. For instance, node 410EM may be a leaf node of data structure 400.

In one or more embodiments, node 410EN may be an optional selection associated with the selection associated with node 410DL. In one example, the optional selection associated with the product associated with node 410BJ may be selected to include a selection associated with the product associated with node 410BJ. In another example, the optional selection associated with the product associated with node 410BJ may not be selected to not include (e.g., exclude) the option selection with the product associated with node 410BJ. In one or more embodiments, node 410EN may store data 450EN. For example, node 410BJ may store a pointer to node 410EN. For instance, node 410EN may not be a leaf node of data structure 400.

In one or more embodiments, node 410FR may be an optional selection associated with the selection associated with node 410EN. In one example, the optional selection associated with the product associated with node 410BJ may be selected to include a selection associated with the product associated with node 410BJ. In another example, the optional selection associated with the product associated with node 410BJ may not be selected to not include (e.g., exclude) the option selection with the product associated with node 410BJ. In one or more embodiments, node 410FR may store data 450FR. For example, node 410BJ may store a pointer to node 410FR. For instance, node 410FR may not be a leaf node of data structure 400.

In one or more embodiments, node 410GC may be an optional attribute associated with the selections associated with node 410FR. In one example, the optional attribute associated with the product associated with node 410BJ may be selected to include an option associated with the product associated with node 410BJ. In another example, the optional attribute associated with the product associated with node 410BJ may not be selected to not include (e.g., exclude) the option associated with the product associated with node 410BJ. In one or more embodiments, node 410GC may store data 450GC. For example, node 410GC may not store a pointer to another node 410. For instance, node 410GC may be a leaf node of data structure 400.

In one or more embodiments, a node 410 associated with a selection may not be a leaf node of data structure 400. In one example, the node 410 associated with the selection may permit one or more options for one or more selections associated with a product and/or one or more attribute associated with the product. In one or more embodiments, a node 410 associated with an attribute may be a leaf node of data structure 400. For example, the node 410 associated with the attribute may not permit one or more options for one or more selections associated with a product and/or one or more attribute associated with the product.

Turning now to FIG. 5, an example of a method of configuring a data structure associated with multiple products is illustrated, according to one or more embodiments. At 510, multiple information respectively associated with multiple products may be received. For example, IHS 110A may receive multiple information respectively associated with multiple products. For instance, IHS 110A may receive multiple information respectively associated with multiple products from IHS 110C via network 215. In one or more embodiments, the multiple products may be associated with a manufacturer of information handling systems.

At 515, pointers to first multiple nodes, at a second level of a recursive data structure, respectively associated with the multiple products may be stored in a first node of a recursive data structure at a first level of the recursive data structure. For example, IHS 110A may store, in a first node of a recursive data structure at a first level of the recursive data structure, pointers to first multiple nodes, at a second level of the recursive data structure, respectively associated with the multiple products. For instance, IHS 110A may store, in a first node 410A of recursive data structure 400 at a first level 470A of recursive data structure 400, pointers to first multiple nodes 410BA-410BJ, at a second level 470B of recursive data structure 400, respectively associated with the multiple products.

At 520, the multiple information may be respectively stored in the first multiple nodes. For example, IHS 110A may respectively store the multiple information in the first multiple nodes. In one or more embodiments, the first multiple nodes may be allocated in a memory medium. For example, IHS 110A may allocate the first multiple nodes in a memory medium.

In one or more embodiments, method elements 525-535 may be performed for each product of the multiple products. At 525, one or more attributes associated with the product and one or more selections associated with the product may be received. For example, IHS 110A may receive one or more attributes associated with the product and one or more selections associated with the product. For instance, IHS 110A may receive one or more attributes associated with the product and one or more selections associated with the product from IHS 110C via network 215. In one or more embodiments, a first attribute of the one or more attributes associated with the product may be or may include a time attribute associated with the product. In one example, the time attribute associated with the product may include an amount of time for which the product is valid. In another example, the time attribute associated with the product may include a billing period of time (e.g., daily, weekly, monthly, yearly, etc.).

At 530, the one or more attributes associated with the product and the one or more selections associated with the product may be stored in multiple nodes of the recursive data structure at a third level of the recursive data structure. For example, IHS 110A may store the one or more attributes associated with the product and the one or more selections associated with the product in multiple nodes of the recursive data structure at a third level of the recursive data structure. For instance, IHS 110A may store the one or more attributes associated with the product and the one or more selections associated with the product in multiple nodes 410 of recursive data structure 400 at a third level 470C of recursive data structure 400.

As an example, IHS 110A may store the one or more attributes associated with the product and the one or more selections associated with the product in multiple nodes 410CA-410CE of recursive data structure 400 at third level 470C of recursive data structure 400. In one instance, a selection associated with a first product associated with node 410BB may be stored in node 410CA of recursive data structure 400 at third level 470C of recursive data structure 400. In a second instance, a selection associated with a second product associated with node 410BJ may be stored in node 410CC of recursive data structure 400 at third level 470C of recursive data structure 400. In a third instance, a selection associated with the second product associated with node 410BJ may be stored in node 410CE of recursive data structure 400 at third level 470C of recursive data structure 400. In a fourth instance, an attribute associated with the first product associated with node 410BB may be stored in node 410CB of recursive data structure 400 at third level 470C of recursive data structure 400. In another instance, an attribute associated with the second product associated with node 410B may be stored in node 410CD of recursive data structure 400 at third level 470C of recursive data structure 400.

In one or more embodiments, recursive data structure 400 may be or may include a file system. For example, data 450 of a node 410 of recursive data structure 400 may be stored via a directory name or a file name of the file system. In one instance, a node 410 associated with a selection may be stored via a directory of the file system. In another instance, node 410 associated with an attribute may be stored via a file of the file system. In one or more embodiments, respectively storing the one or more attributes associated with the product and the one or more selections associated with the product in the multiple nodes of the recursive data structure at the third level of the recursive data structure may include: respectively storing the one or more attributes associated with the product in one or more files of a file system and respectively storing the one or more selections associated with the product in one or more directories of the file system. For example, method element 530 may include method elements 5432 and 534. In one instance, the one or more attributes associated with the product may be respectively stored in one or more files of a file system, at 532. In another instance, the one or more selections associated with the product may be respectively stored in one or more directories of the file system, at 534.

At 535 multiple addresses of the multiple nodes of at the third level of the recursive data structure may be respectively stored in a node of the first multiple nodes associated with the product. For example, IHS 110A may respectively store multiple addresses of the multiple nodes of at the third level of the recursive data structure in a node of the first multiple nodes associated with the product. In one instance, IHS 110A may store addresses of nodes of 410CA and 410CB at third level 470C of recursive data structure 400 in node 410BB associated with the product. In another instance, IHS 110A may store addresses of nodes of 410CC-410CE at third level 470C of recursive data structure 400 in node 410BJ associated with the product.

In one or more embodiments, method elements 540-545 may be performed for each product of the multiple products and for each selection of the one or more selections associated with the product. At 540, one or more attributes associated with the selection may be received. For example, IHS 110A may receive one or more attributes associated with the selection. For instance, IHS 110A may receive one or more attributes associated with the selection from IHS 110C via network 215.

At 545, the one or more attributes associated with the selection may be stored in one or more nodes of the recursive data structure at a fourth level of the recursive data structure. For example, IHS 110A may store the one or more attributes associated with the selection in one or more nodes of the recursive data structure at a fourth level of the recursive data structure. For instance, IHS 110A may store the one or more attributes associated with the selection in one or more nodes 410 of recursive data structure 400 at a fourth level 470D of recursive data structure 400. As an example, IHS 110A may store the one or more attributes associated with the product and the one or more selections associated with the product in multiple nodes 410DA-410DL of recursive data structure 400 at fourth level 470D of recursive data structure 400. In one instance, a selection associated with the first selection associated with node 410CA may be stored in node 410DA of recursive data structure 400 at fourth level 470D of recursive data structure 400. In a second instance, a selection associated with the second selection associated with node 410CC may be stored in node 410DB of recursive data structure 400 at fourth level 470D of recursive data structure 400. In a third instance, a selection associated with the third selection associated with node 410CE may be stored in node 410DL of recursive data structure 400 at fourth level 470D of recursive data structure 400. In another instance, an attribute associated with the second selection associated with node 410CC may be stored in node 410DK of recursive data structure 400 at fourth level 470D of recursive data structure 400.

In one or more embodiments, the recursive data structure may include more than four levels. For example, recursive data structure 400 may include a fifth level 470E, a sixth level 470F, and a seventh level 470G, among others. Although levels 470A-470G are illustrated, recursive data structure may include any number of levels, according to one or more embodiments.

In one or more embodiments, one or more of the method and/or process elements and/or one or more portions of a method and/or a process element may be performed in varying orders, may be repeated, or may be omitted. Furthermore, additional, supplementary, and/or duplicated method and/or process elements may be implemented, instantiated, and/or performed as desired, according to one or more embodiments. Moreover, one or more of system elements may be omitted and/or additional system elements may be added as desired, according to one or more embodiments.

In one or more embodiments, a memory medium may be and/or may include an article of manufacture. For example, the article of manufacture may include and/or may be a software product and/or a program product. For instance, the memory medium may be coded and/or encoded with processor-executable instructions in accordance with at least a portion of one or more flowcharts, at least a portion of one or more systems, at least a portion of one or more methods, and/or at least a portion of one or more processes described herein to produce the article of manufacture.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. An information handling system, comprising:
at least one processor; and
a memory medium, coupled to the at least one processor, that stores instructions executable by the at least one processor, which when executed by the at least one processor, cause the information handling system to:
receive a plurality of information respectively associated with a plurality of products;
store, in a first node of a recursive data structure at a first level of the recursive data structure, pointers to a first plurality of nodes, at a second level of the recursive data structure, respectively associated with the plurality of products;
respectively store the plurality of information in the first plurality of nodes;
for each product of the plurality of products:
receive one or more attributes associated with the product and one or more selections associated with the product; and
respectively store the one or more attributes associated with the product and the one or more selections associated with the product in a plurality of nodes of the recursive data structure at a third level of the recursive data structure; and
for each product of the plurality of products:
for each selection of the one or more selections associated with the product:
receive one or more attributes associated with the selection; and
respectively store the one or more attributes associated with the selection in one or more nodes of the recursive data structure at a fourth level of the recursive data structure.

2. The information handling system of claim 1, wherein the one or more attributes associated with the product includes a plurality of attributes associated with the product.

3. The information handling system of claim 1, wherein the instructions further cause the information handling system to:
for each product of the plurality of products:
respectively store a plurality of addresses of the plurality of nodes of at the third level of the recursive data structure in a node of the first plurality of nodes associated with the product.

4. The information handling system of claim 1, wherein the recursive data structure includes a file system.

5. The information handling system of claim 4, wherein data of a node of the recursive data structure is stored via a directory name or a file name of the file system.

6. The information handling system of claim 4, wherein, for each product of the plurality of products, to respectively store the one or more attributes associated with the product and the one or more selections associated with the product in the plurality of nodes of the recursive data structure at the third level of the recursive data structure, the instructions further cause the information handling system to:
respectively store the one or more attributes associated with the product in one or more files of the file system; and
respectively store the one or more selections associated with the product in one or more directories of the file system.

7. The information handling system of claim 1, wherein a first attribute of the one or more attributes associated with the product is a time attribute associated with the product.

8. A method, comprising:
receiving, by an information handling system, a plurality of information respectively associated with a plurality of products;
storing, by the information handling system in a first node of a recursive data structure at a first level of the recursive data structure, pointers to a first plurality of nodes, at a second level of the recursive data structure, respectively associated with the plurality of products;
respectively storing, by the information handling system, the plurality of information in the first plurality of nodes;
for each product of the plurality of products:
receiving, by the information handling system, one or more attributes associated with the product and one or more selections associated with the product; and
respectively storing, by the information handling system, the one or more attributes associated with the product and the one or more selections associated with the product in a plurality of nodes of the recursive data structure at a third level of the recursive data structure; and
for each product of the plurality of products:
for each selection of the one or more selections associated with the product:
receiving, by the information handling system, one or more attributes associated with the selection; and
respectively storing, by the information handling system, the one or more attributes associated with the selection in one or more nodes of the recursive data structure at a fourth level of the recursive data structure.

9. The method of claim 8, wherein the one or more attributes associated with the product includes a plurality of attributes associated with the product.

10. The method of claim 8, further comprising:
for each product of the plurality of products:
respectively storing, by the information handling system, a plurality of addresses of the plurality of nodes of at the third level of the recursive data structure in a node of the first plurality of nodes associated with the product.

11. The method of claim 8, wherein the recursive data structure includes a file system.

12. The method of claim 11, wherein data of a node of the recursive data structure is stored via a directory name or a file name of the file system.

13. The method of claim 11, wherein, for each product of the plurality of products, the respectively storing the one or more attributes associated with the product and the one or more selections associated with the product in the plurality of nodes of the recursive data structure at the third level of the recursive data structure includes:
respectively storing the one or more attributes associated with the product in one or more files of the file system; and
respectively storing the one or more selections associated with the product in one or more directories of the file system.

14. The method of claim 8, wherein a first attribute of the one or more attributes associated with the product is a time attribute associated with the product.

15. A computer-readable non-transitory memory medium that includes instructions that, when executed by at least one processor of an information handling system, cause the information handling system to:
receive a plurality of information respectively associated with a plurality of products;
store, in a first node of a recursive data structure at a first level of the recursive data structure, pointers to a first plurality of nodes, at a second level of the recursive data structure, respectively associated with the plurality of products;
respectively store the plurality of information in the first plurality of nodes;
for each product of the plurality of products:
receive one or more attributes associated with the product and one or more selections associated with the product; and
respectively store the one or more attributes associated with the product and the one or more selections associated with the product in a plurality of nodes of the recursive data structure at a third level of the recursive data structure; and
for each product of the plurality of products:
for each selection of the one or more selections associated with the product:
receive one or more attributes associated with the selection; and
respectively store the one or more attributes associated with the selection in one or more nodes of the recursive data structure at a fourth level of the recursive data structure.

16. The computer-readable non-transitory memory medium of claim 15, wherein the one or more attributes associated with the product includes a plurality of attributes associated with the product.

17. The computer-readable non-transitory memory medium of claim 15, wherein the instructions further cause the information handling system to:
for each product of the plurality of products:
respectively store a plurality of addresses of the plurality of nodes of at the third level of the recursive data structure in a node of the first plurality of nodes associated with the product.

18. The computer-readable non-transitory memory medium of claim 15, wherein the recursive data structure includes a file system.

19. The computer-readable non-transitory memory medium of claim 18, wherein data of a node of the recursive data structure is stored via a directory name or a file name of the file system.

20. The computer-readable non-transitory memory medium of claim 18, wherein, for each product of the plurality of products, to respectively store the one or more attributes associated with the product and the one or more selections associated with the product in the plurality of nodes of the recursive data structure at the third level of the recursive data structure, the instructions further cause the information handling system to:
respectively store the one or more attributes associated with the product in one or more files of the file system; and
respectively store the one or more selections associated with the product in one or more directories of the file system.
